(19) United States
(12) Patent Application Publication
(10) Pub. No.: US 2012/0134244 A1
(43) Pub. Date: May 31, 2012

(54) System and Method for Easy Change Jewelry Case Cover

(75) Inventor: Enrico Margaritelli, Hollywood, FL (US)

(73) Assignee: Crown International Properties Establishment, Mauren (LI)

(21) Appl. No.: 13/383,477

(22) PCT Filed: Jun. 21, 2011
(86) PCT No.: PCT/US11/41170

§ 371 Date: Feb. 10, 2012

Related U.S. Application Data
(60) Provisional application No. 61/344,259, filed on Jun. 21, 2010.

(51) Int. Cl. G04B 37/00; A44C 5/00; A44C 9/00; A44C 7/00; A44C 25/00; A44C 1/00

(52) U.S. Cl. 368/281; 63/33; 63/20; 63/15; 63/12; 63/3

(57) ABSTRACT

A jewelry assembly comprising an upper case cover having at least one indentation on an inner surface and a notch on a lower outside surface; a lower case for housing a main jewelry body, the lower case comprising at least one uniball system including an inner spring and spherical ball that protrudes from the lower case; wherein the upper case is releaseably securable to the lower case by aligning the at least one indentation to the at least one uniball and applying a downward pressure to the upper case; and wherein the upper case is releasable from the lower case by applying an upward pressure at the notch of the upper case.

This application claims the benefit of U.S. Provisional Patent Application No. 61/344,259, filed Jun. 21, 2010 and PCT/US/2011/041170, filed on Jun. 21, 2011, both of which are hereby incorporated herein by reference.

### FIELD OF THE INVENTION

The present invention relates to a system and method for easily changing case covers of jewelry such as watches, rings, and brooches.

### BACKGROUND OF THE INVENTION

A number of watch manufacturers have designed watches that allow the user to change certain aspects of the watch. For example, some watches have interchangeable bands, or interchangeable colored rings that can be placed around the top of the face of the watch or around the outside circumference of the watch. The colored rings generally are made of plastic or rubber, and the interchangeable parts allow the user to change only one aspect of the watch, that being the color of the ring. Similarly, ring manufacturers also have designed rings that may have interchangeable colored rings that are placed around stones or other decorative parts of the rings. However, these attempts to achieve interchangeability require the user to use a screwdriver or various other tools and remove small screws at the side of the watch case cover or ring, or render the jewelry unattractive as the addition is plastic. This makes the interchangeability complicated and difficult for a user to do.

A system is needed to allow a user to easily change the entire watch case cover or ring cover or other type of jewelry easily. Moreover, a system is needed that allows a user to change not only the color, but shape and overall design of jewelry.

### SUMMARY OF THE INVENTION

Accordingly, the present invention is directed to a method and system that substantially obviates one or more of the problems due to limitations and disadvantages of the related art. The present invention allows a user, for example, to change the entire case cover of a watch by replacing the top part of the entire watch. With the present invention, a user can push the case cover up and off the watch with a finger. This system allows the case cover to align perfectly and snap into and out of place.

The invention further allows a user to change the shape of the jewelry, the color of the jewelry, and the composition of the jewelry.

Additional features and advantages of the invention will be set forth in the description that follows, and in part will be apparent from the description, or may be learned by practice of the invention. The objectives and advantages of the invention will be realized and attained by the method that is particularly pointed out in the written description and claims hereof as well as the appended drawings.

To achieve these and other advantages, and in accordance with the purpose of the invention, as embodied and broadly described, the present invention provides A jewelry assembly comprising an upper case cover having at least one indentation on an inner surface and a notch on a lower outside surface; a lower case for housing a main jewelry body, the lower case comprising at least one uniball system including an inner spring and spherical ball that protrudes from the lower case; wherein the upper case is releaseably securable to the lower case by aligning the at least one indentation to the at least one uniball and applying a downward pressure to the upper case; and wherein the upper case is releasable from the lower case by applying an upward pressure at the notch of the upper case.

Another aspect of the invention provides watch assembly comprising an upper case cover having at least one indentation on an inner surface and a notch on a lower outside surface; a lower case for housing electrical and mechanical component of the watch, the lower case comprising at least one uniball system including an inner spring and spherical ball; wherein the upper case is releaseably securable to the lower case by aligning the at least one indentation to the at least one uniball and applying a downward pressure to the upper case; and wherein the upper case is releasable from the lower case by applying an upward pressure at the notch of the upper case.

It is to be understood that both the foregoing general description and the following detailed description are exemplary and explanatory and are understood to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 is a front view of a watch with the case cover of an embodiment of the present invention.

FIG. 2 is a side view of a watch and case cover of an embodiment of the present invention.

FIG. 3 is a side view of a watch and case cover illustrating the inner dimensions of an embodiment of the present invention.

FIG. 4 is a side view of the uniball system of a watch of an embodiment of the present invention.

FIG. 5 is a side view illustrating the releasability of a watch and case cover of an embodiment of the present invention.

### DESCRIPTION OF THE PREFERRED EMBODIMENTS

Reference will now be made in detail to the preferred embodiments of the present invention, examples of which are illustrated in the accompanying drawings. The present invention described below extends the functionality of the inventive system and method for easy change jewelry case cover.

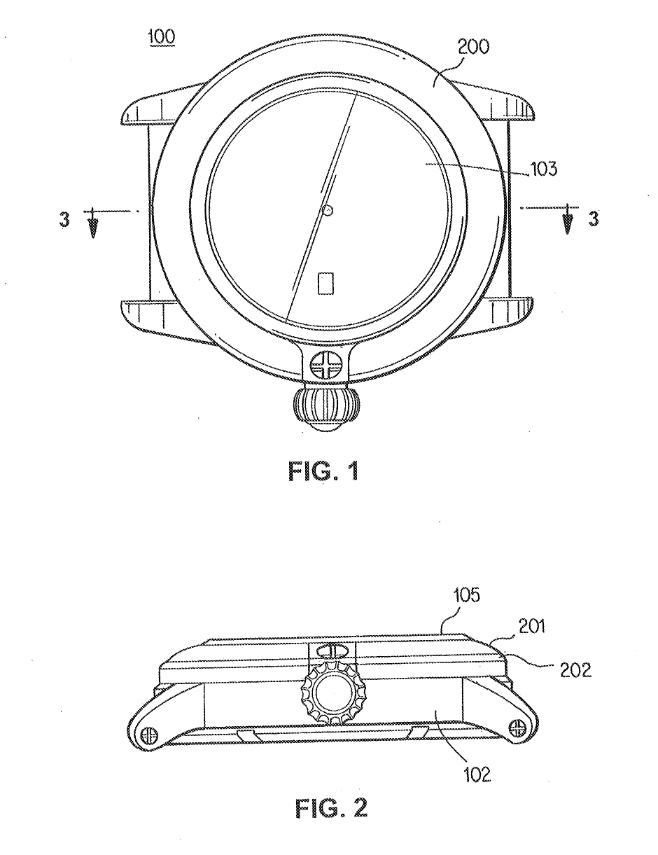

FIG. 1 is a front view of a watch 100 with the upper case cover 200 of an embodiment of the present invention, and FIG. 2 is a side view of the watch 100 and upper case cover 200 of an embodiment of the present invention. The watch 100 may include a casing 102 and a display 103. The casing 102 encloses the electrical and/or mechanical components that execute the chronometer and other functions of the watch 100. The display 103 displays the data produced by the chronometer and other functions of the watch 100. The display 103 may include a liquid crystal display, a light emitting diode display, an analog display such as hands or dials, or any type of watch display known to those skilled in the art.

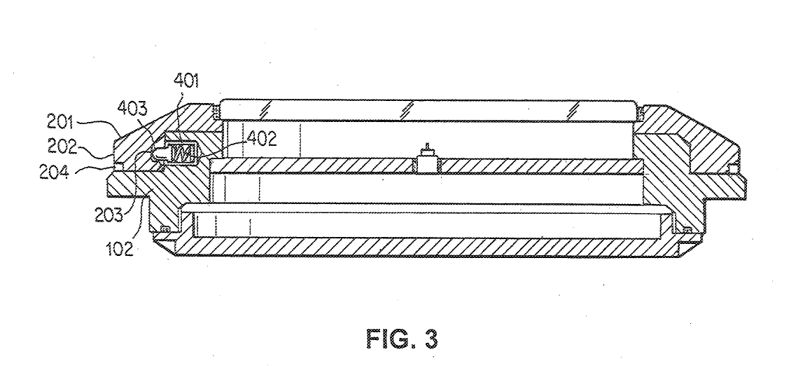

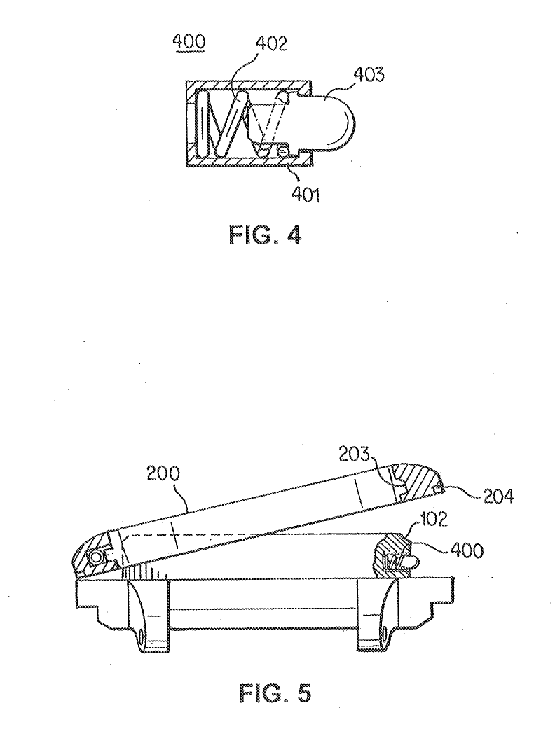

As shown in FIG. 3, the casing 102 further may include at least one uniball system 400 including an inner spring and spherical ball. The uniball system may move in and out of the casing as the upper case cover 200 is removed or snapped into place, as will be discussed later. FIG. 4 illustrates the uniball system. As shown in FIG. 4, the uniball system 400 may be a small cylinder 401 encompassing an inner spring 402 and spherical ball 403 that allows movement of the spherical ball in and out of the casing. The spherical ball generally protrudes from the casing 102. When the spherical ball 403 is pushed, the spring 402 allows the spherical ball to quickly move into the cylinder 401, thus becoming flush with the outer surface of the casing 102. Once pressure is released, the spherical ball again protrudes beyond the outer surface of the casing.

As shown in FIGS. 1 and 4, a watch embodiment of the present invention also may include an upper case cover, or bezel 200, which includes a top surface ring 201 that surrounds the watch's crystal 105 (shown in FIG. 2) on the top of the casing 102 and a band 202 at the bottom of the top surface ring 201. The band 202 may have the approximate same dimensions as the watch casing 102. The upper case cover 200 is independent from the display 103 and the casing 102. The upper case cover 200 may have at least one indentation 203 on an inner surface of the band 202 and a notch 204 on a lower outside surface of the band 202. The notch 204 may be directly below the indentation 203.

As shown in FIGS. 4 and 5, the upper case cover 200 is releasably securable to the casing 102 by aligning the at least one indentation 203 to the spherical ball 403 of the at least one uniball system 400 and applying a downward pressure to the upper case cover 200. Once pressure is applied, the upper case cover 200 snaps into place and is secure. Moreover, the upper case cover 200 is releasable from the casing 102 by applying an upward pressure at the notch 204 of the upper case cover 200. This pressure again engages the uniball system's inner spring 402, which allows the spherical ball 403 to recede into the casing 102 and disengage the upper case cover 200. Once the upper case cover 200 is removed (or pressure is released from the uniball system 400, the spring 402 again pushes the spherical ball 403 out so that it protrudes from the casing 102.

The upper case cover will change the look and feel of the watch, depending on the upper case cover. For example, upper case covers may be different colors, made of different materials (including, but not limited to, metal, rubber, gold, silver, ceramic, carbon fiber, aluminum, Titanium), may have jewels of all varieties embedded, may have other types of designs etched into the cover. Moreover, while the casing my generally be round, the top surface ring may be any shape imaginable. The band 202 may be circular to be releasably secured to a round casing 102 while the top surface of the upper case cover 200 may be square, triangular, etc. Similarly, the band 202 may be square or any other shape that can be reliably secured to a square or any other shaped casing of the watch or jewelry. Accordingly, one watch may appear round at one time, but with an upper case cover having a square upper surface releaseably secured to the same watch, it will appear square. The change may be made in seconds.

While the figures of this embodiment illustrate a watch with a circular casing, the casing may be of any shape and the upper case cover, therefore, will have a similar band shape as the casing.

Moreover, the upper case cover may have two or more indentations, with the casing having an equal number of uniball systems that align with the indentations. Similarly, the upper case cover may have two or more notches to aid in releasing the upper case cover.

In a second embodiment, a brooch may include a casing that encloses any type of decorative design. Similar to the first embodiment, the casing further may include at least one uniball system. The description of the uniball system is the same as given for the watch embodiment above.

The brooch of the present invention also may include an upper case cover, which includes a top surface that surrounds the decorative design of the brooch on the top of the casing and a band at the bottom of the top surface ring. The band has the approximate same shape and dimensions as the brooch casing. The upper case cover is independent from the decorative design and the casing. Similar to the embodiment of the watch, the upper case cover of the brooch may have at least one indentation on an inner surface of the band and a notch on a lower outside surface of the band. The notch may be directly below the indentation.

The upper case cover of the brooch is releasably securable to the casing by aligning the at least one indentation to the at least one uniball and applying a downward pressure to the upper case. Once pressure is applied, the upper case cover snaps into place and is secure. Moreover, the upper case cover is releasable from the lower case by applying an upward pressure at the notch of the upper case cover. This pressure again engages the uniball system's inner spring, which allows the ball to recede into the casing and disengage the upper case cover. Once the upper case cover is removed (or pressure is released from the uniball system), the spring again pushes the uniball out so that it protrudes from the casing.

The upper case cover will change the look and feel of the brooch, depending on the upper case cover. For example, upper case covers may be different colors, made of different materials (metal, rubber, gold, silver), may have jewels of all varieties embedded, may have other types of designs etched into the cover. Moreover, the top surface may be any shape imaginable no matter the original shape of the brooch. The lower band will be releaseably secured to the casing while the top surface may be square, triangular, etc.

A third embodiment may be a ring having releasably secured case covers. The description of this embodiment is the same as for the watch and brooch and need not be repeated here.

The foregoing description has been given in the context of watches, brooches, and rings. It will be apparent, however, that the present invention is applicable to other types of jewelry known to those skilled in the art, such as pendants, earrings, and bracelets. This list, of course, is not exclusive.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A jewelry assembly comprising:
an upper case cover having at least one indentation on an inner surface and a notch on a lower outside surface;
a lower case for housing a main jewelry body, the lower case comprising at least one uniball system including an inner spring and spherical ball that protrudes from the lower case;
wherein the upper case is releaseably securable to the lower case by aligning the at least one indentation to the at least one uniball and applying a downward pressure to the upper case; and
wherein the upper case is releasable from the lower case by applying an upward pressure at the notch of the upper case.

2. The jewelry assembly of claim 1, wherein the jewelry assembly is a watch.

3. The jewelry assembly of claim 1, wherein the jewelry assembly is a brooch.

4. The jewelry assembly of claim 1, wherein the jewelry assembly is a ring.

5. The jewelry assembly of claim 1, wherein the jewelry assembly is a pendant.

6. The jewelry assembly of claim 1, wherein the jewelry assembly is an earring.

7. The jewelry assembly of claim 1, wherein the jewelry assembly is a bracelet.

8. The jewelry assembly of claim 1, wherein the lower case comprises at least two uniball systems.

9. The jewelry assembly of claim 1, wherein the upper case comprises at least two indentations on an inner surface and at least two notches on a lower outside surface.

10. The jewelry assembly of claim 1, wherein the upper case cover comprises a top surface and a band.

11. The jewelry assembly of claim 10, wherein the band has the same dimensions as the lower case and the top surface has a different shape than the lower case.

12. The jewelry assembly of claim 1, wherein the upper case is a different color than the lower case.

13. The jewelry assembly of claim 1, wherein the upper case includes jewels embedded therein

14. A watch assembly comprising:
an upper case cover having at least one indentation on an inner surface and a notch on a lower outside surface;
a lower case for housing electrical and mechanical components of the watch, the lower case comprising at least one uniball system including an inner spring and spherical ball that protrudes from the lower case;
wherein the upper case is releaseably securable to the lower case by aligning the at least one indentation to the at least one uniball and applying a downward pressure to the upper case; and
wherein the upper case is releasable from the lower case by applying an upward pressure at the notch of the upper case.

15. The watch assembly of claim 14, wherein the lower case comprises at least two uniball systems.

16. The watch assembly of claim 14, wherein the upper case comprises at least two indentations on an inner surface and at least two notches on a lower outside surface.

17. The watch assembly of claim 14, wherein the upper case cover comprises a top surface and a band.

18. The watch assembly of claim 17, wherein the band has the same dimensions as the lower case and the top surface has a different shape than the lower case.

19. The watch assembly of claim 14, wherein the upper case is a different color than the lower case.
